(19) United States
(12) Patent Application Publication
(10) Pub. No.: US 2014/0179354 A1
(43) Pub. Date: Jun. 26, 2014

(54) DETERMINING CONTACT OPPORTUNITIES

(71) Applicants: Ian David Robert Fisher, San Rafael, CA (US); Daniel William James McCall, San Rafael, CA (US); John Jacob Ellenich, San Francisco, CA (US)

(72) Inventors: Ian David Robert Fisher, San Rafael, CA (US); Daniel William James McCall, San Rafael, CA (US); John Jacob Ellenich, San Francisco, CA (US)

(21) Appl. No.: 13/725,172

(22) Filed: Dec. 21, 2012

(51) Int. Cl. H04W 4/02

(52) U.S. Cl. CPC H04W 4/02
USPC 455/456.3

(57) ABSTRACT

Methods, systems, and apparatus, including computer programs encoded on a computer storage medium, for obtaining data describing one or more customer contacts of a user from a third-party content provider; matching the one or more customer contacts to respective additional third-party content associated with the one or more customer contacts; deriving geographic location information for one or more of the customer contacts based on the additional third-party content; receiving a geographic location of the user; determining one or more contact opportunities based on the geographic location of the user, the geographic location information for the one or more customer contacts, and one or more presentation criteria; and providing data describing the one or more contact opportunities to a user device for presentation, wherein the data is presented on a user interface of the user device.

### BACKGROUND

This specification relates to information retrieval.

A user can access a customer database to obtain information, e.g., customer names and contact information, for potential customers. The user can use the obtained information to make sales pitches to the potential customers, for example, by sending e-mails, letters, making phone calls, or by visiting the potential customers at their residence or business address.

### SUMMARY

An opportunity system can provide information to a user device identifying contact opportunities with respect to the user's contacts, e.g., potential customers. The opportunity system can determine opportunities for making contact with the user's contacts by deriving contemporaneous geographic locations of the contacts based on third-party content, e.g., content item tags in a social network content feed, that is associated with the user's contacts. The opportunity system can determine contact opportunities based on a geographic location of the user device, respective geographic locations of the user's contacts, and/or one or more presentation criteria. The determined contact opportunities can be presented to the user on an interface on the user device, e.g., a map interface or push notification to a device.

In general, one aspect of the subject matter described in this specification can be embodied in methods that include the actions of obtaining data describing one or more customer contacts of a user from a third-party content provider; matching the one or more customer contacts to respective additional third-party content associated with the one or more customer contacts; deriving geographic location information for one or more of the customer contacts based on the additional third-party content; receiving a geographic location of the user; determining one or more contact opportunities based on the geographic location of the user, the geographic location information for the one or more customer contacts, and one or more presentation criteria; and providing data describing the one or more contact opportunities to a user device for presentation, wherein the data is presented on a user interface of the user device. Other embodiments of this aspect include corresponding systems, apparatus, and computer program products.

These and other embodiments can optionally include one or more of the following features. The geographic location information for one or more of the customer contacts is derived based on a respective content item tag and an elapsed time of the respective content item tag. The additional third-party content comprises content feeds from one or more social networks. The data describing the one or more contact opportunities includes a respective contact name, title, contact information, potential monetary value of sales opportunity, contact interest level, lead status, or an estimated likelihood of success, or a relevance to the user. The data describing the one or more contact opportunities includes geographic locations of the one or more contact opportunities, the geographic locations being presented on a map interface of the user device.

The data describing the one or more contact opportunities includes a respective contact name and a potential value of sales opportunity, the respective contact name and potential value of sales opportunity being presented in a push notification to the user device. Determining one or more contact opportunities based on the geographic location of the user, the geographic location information for one or more of the customer contacts, and one or more presentation criteria includes determining, based on the geographic location information for the customer contacts, that a customer contact is located within a threshold distance to the geographic location of the user; and determining that the customer contact satisfies one or more presentation criteria, the presentation criteria comprising a respective potential monetary value of a sales opportunity, customer interest level, lead status, and a likelihood of success, or a relevance to the user. Matching the one or more customer contacts to additional third-party content associated with one or more of the customer contacts includes identifying respective e-mail addresses associated with the one or more customer contacts; identifying additional third-party content that is associated with the respective e-mail addresses, wherein the additional third-party content includes geographic location data; and determining, using the identified additional third-party content, respective geographic locations for the one or more customer contacts. The geographic location is determined based on a geographic location name referenced in the additional third-party content. The geographic location is determined based on a network address of a user device that was used to provide the additional third-party content to a content provider. The geographic location is determined based on a check-in location referenced in the additional third-party content.

Particular embodiments of the subject matter described in this specification can be implemented so as to realize one or more of the following advantages. A user can be notified of opportunities for making contact with potential customers based the potential customer's geographic location, e.g., office location or contemporaneous location, in relation to the user's geographic location. Users can specify additional presentation criteria for filtering contact opportunities, for example, based on distance to the potential customer and the potential value of the potential customer. Other presentation criteria can include a measure of relevance of the contact opportunity to the user, for example based on one or more of a geographic frequency, freshness of the contact opportunity's location, the contact opportunity's location relative to the user's location, identification by the user of relevant contacts, and designations of contact opportunities as associated with the user.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system that can provide contact opportunities for users.

FIG. 2 is a flow diagram of an example process for obtaining contact opportunities.

FIG. 3 illustrates an example interface for presenting information describing contacts and contact opportunities that were identified for a user.

FIG. 4 illustrates an example interface for presenting a listing of contacts that were identified for a user.

FIG. 5 illustrates an example map interface indicating office locations of contacts that were identified for a user.

FIG. 6 illustrates an example map interface indicating social locations of contacts that were identified for a user.

FIG. 7 illustrates an example map interface indicating locations of contacts that were identified for a user.

FIG. 8 illustrates an example push notification displayed on an interface of a user device.

FIG. 9 illustrates an example interface displaying a contact's location history.

Like reference numbers and designations in the various drawings indicate like elements.

### DETAILED DESCRIPTION

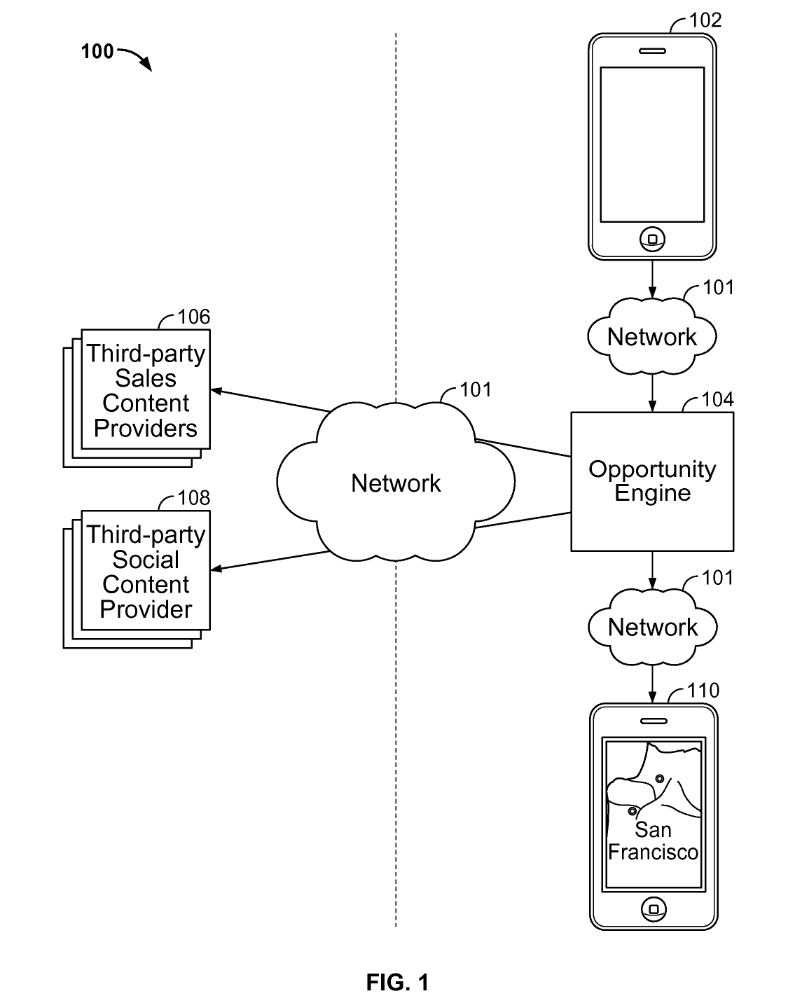

FIG. 1 is a block diagram of an example system 100 that can provide contact opportunities for users. The system 100 is an example of a contact opportunity system implemented as one or more computer programs on one or more computers in one or more locations, in which the systems, components, and techniques described below can be implemented. The contact opportunity system 100 includes an opportunity system 104 that is configured to communicate with third-party sales content providers 106 and third-party social content providers 108 through a network 101, e.g., a local area network (LAN) or wide area network (WAN), e.g., the Internet, or a combination of networks. Although this specification describes interaction with third-party social content providers 108, the type of content used is not limited to social content and can include any accessible data that can be cross-referenced with a user's contacts.

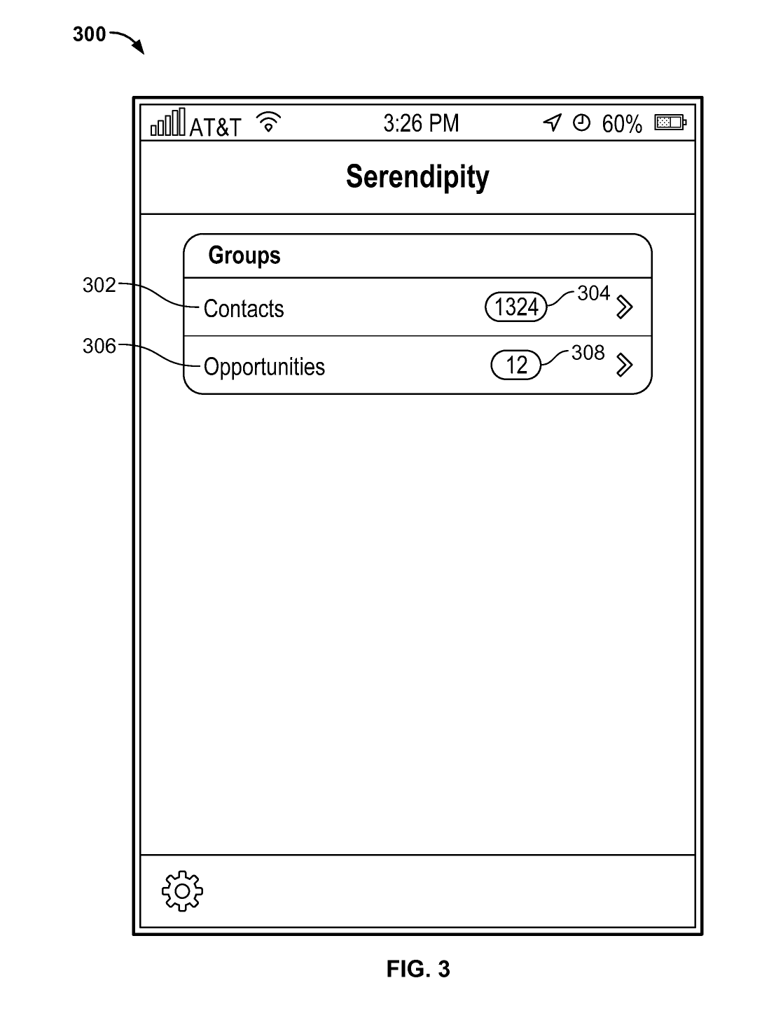

A user operating a user device 102 can communicate with the opportunity system 104 through the network 101, e.g., using wi-fi, 3G, 4G, etc. The user device 102 will generally include a memory, e.g., a random access memory (RAM), for storing instructions and data and a processor for executing stored instructions. The memory can include both read only and writable memory. The user device 102 can respectively be one of various types of computing devices, e.g., a cloud client device, a smartphone, a tablet device, or a personal digital assistant. The user device 102 can run an application program, e.g., a web browser or mobile application, that can interact with the opportunity system 104 to obtain contact opportunities, e.g., opportunities for interacting with the user's contacts. The opportunity system 104 can provide the requested data to the user device 102 for presentation on a user interface of the user device, as described in reference to FIGS. 3-9. Further, the user device 102 can also provide the opportunity system 104 with geographic location data, e.g., Global Positioning System (GPS) data, that indicates a geographic location of the user device 102.

In some implementations, a user operating the user device 102 can obtain data describing contact opportunities by providing user login credentials, e.g., a user identifier and password, for one or more third-party sales content providers 106 to an application program that is running on the user device 102. For example, the user device 102 can provide user login credentials to the opportunity system 104. In some implementations, the opportunity system 104 uses the login credentials to obtain, from a third-party sales content provider 106, data describing contacts, e.g., customer contacts, that are associated with the user. Alternatively, the user device 102 is configured to obtain, from the third-party sales content provider 106, data describing contacts that are associated with the user, and to provide the obtained data to the opportunity system 104. In some implementations, the user is associated with a tenant, e.g., one of multiple companies affiliated with the opportunity system, that provides the opportunity system with access to one or more databases that include information describing contacts that are associated with the user.

The data describing the contacts can include, for example, a respective contact name, title, company information (e.g., company name, business addresses, phone numbers), contact information (e.g., personal addresses, business addresses, e-mail addresses, phone numbers), social information (e.g., one or more of usernames that identify the contact's third-party social accounts), information describing the contact's sales transactional history with the user (e.g., previous transactions and respective monetary values of previous transactions), a potential monetary value of sales opportunities with the contact, the contact's interest level in entering into a sales transaction, an estimated likelihood of the user succeeding in concluding a sales transaction with the contact, and a lead status (e.g., a status indicating whether the contact has been contacted, pitched, the whether sales pitch was successful, and whether a follow-up sales pitch is needed).

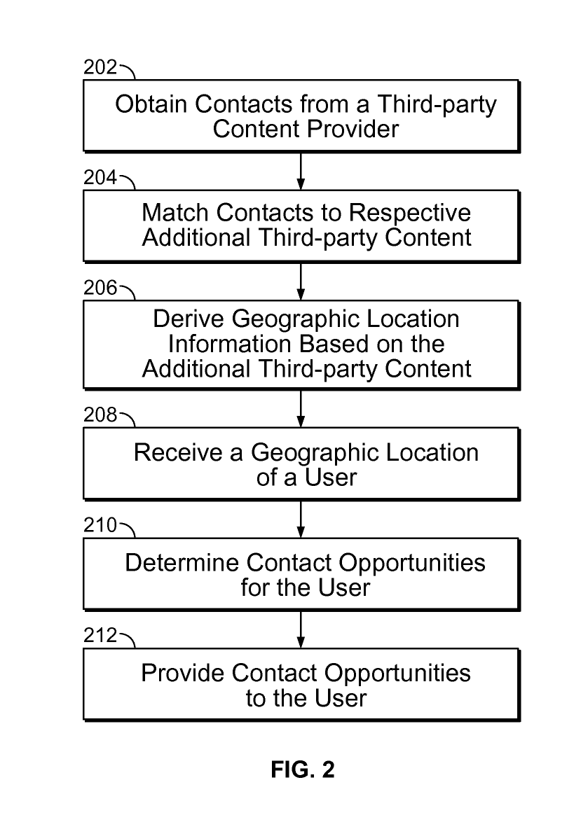

The opportunity system 104 is configured to use the data describing the contacts to match contacts to additional third-party content that is associated with the respective contacts. For example, an individual “John Smith” identified as a user contact, e.g., a potential customer, can be matched to other third-party content associated with John Smith. Third-party content can include content items that reference, for example, blog posts in third-party websites, tags in content feeds from one or more third-party social networks, posts in third-party message boards, and social check-ins that identify a geographic location or point of interest. The opportunity system 104 can derive geographic location information from the obtained third-party content items, as described in reference to FIG. 2.

In some implementations, the opportunity system 104 uses a contact's e-mail address to identify and obtain, from one or more third-party social content providers 108, third-party content that is associated with the contact. Other types of information, e.g., information identifying a person, can be used to perform the matching. For example, the opportunity system 104 can use a contact's obtained username or phone number that identifies the contact's third-party social accounts, e.g., content feeds from one or more social networks. In some implementations, the opportunity system 104 provides a portion of the data describing the contacts, e.g., e-mail addresses, to the third-party social content providers 108, and, in response, the third-party social content providers 108 provide third-party content associated with the contacts. In some implementations, users provide the opportunity system 104 with information describing the user's contacts to aid in obtaining and matching third-party content. For example, the user can provide one or more identifiers associated with particular contacts that can be used to determine matching third-party content, e.g., alternative e-mail address, a username for social feeds, etc. In some implementations, the opportunity system 104 is configured to identify a user's contacts by referencing one or more social graphs that describe a user's relationship with the user's contacts.

The opportunity system 104 is further configured to determine contact opportunities for the user. In some implementations, the opportunity system 104 determines contact opportunities based on the user's geographic location and contemporaneous geographic location information that was derived for the user's contacts. For example, the opportunity system 104 can determine, based on respective geographic location information for the user's contacts, that one or more contacts are located within a threshold distance to the geographic location of the user. The threshold distance can be a default distance or can be user specified. Additionally, in some implementations, the user can specify different threshold distances for different contacts or categories of contacts, as described in greater detail below. The opportunity system 104 can identify contacts that are within the threshold distance as contact opportunities for the user.

In some implementations, the opportunity system 104 determines contact opportunities based on the geographic location of the user, the geographic location information that was derived for the user's contacts, one or more presentation criteria, and/or a combination thereof. The presentation criteria can include satisfying a threshold potential monetary value of a sales opportunity with a contact. For example, the user can specify a threshold potential monetary value of a sales opportunity as $10,000 and, in response, the opportunity system 104 can identify contact opportunities with particular contacts that are within a threshold distance to the geographic location of the user, and that have a potential monetary value of a sales opportunity of at least $10,000. The threshold distance can be a default distance or can be user specified.

The presentation criteria can also include satisfying a threshold customer interest level in entering into a sales transaction with the user. For example, the user can specify a threshold customer interest level as a numeric value, e.g., 80 percent, or as a category, e.g., “moderately interested” and, in response, the opportunity system 104 can identify contact opportunities with contacts that are within a threshold distance to the geographic location of the user, and that have an interest level that meets or exceeds the threshold, e.g., an interest level meeting or exceeding 80 percent or “moderately interested.” The presentation criteria can also include satisfying a threshold likelihood of the user succeeding in concluding a sales transaction with the contact. Additionally, the presentation criteria can include satisfying a threshold lead status.

The opportunity system 104 can determine contact opportunities based on a combination of the geographic location of the user, the geographic location information that was derived for the user's contacts, and one or more presentation criteria. For example, the user can set a higher threshold distance for contacts having a potential monetary value in excess of a specified value. In another example, the user can set a higher threshold distance for contacts having a lead status indicating that the contact has not been contacted and a lower threshold distance for contacts having a lead status indicating that a follow-up pitch is needed. Additionally, the user can specify threshold distances for particular users, e.g., a higher threshold distance can be specified for an important contact.

In some implementations, users can configure the opportunity system 104 to exclude notifications about particular contact opportunities e.g., associated with specific contacts. In some implementations, the opportunity system 104 is configured to limit the notification frequency for contact opportunities. For example, the system can establish, or the users can specify, a limit on a number of contact opportunities presented for an individual contact e.g., within a specified amount of time. The opportunity system 104 can also be configured to loosen presentation criteria, e.g., setting a higher threshold distance, for contacts that are associated with a geographic region that is different from the geographic region in which the user is located. For example, if a user's contact is associated with New York City, N.Y., and that contact is now determined to be located 10 miles away from the user in San Francisco, Calif., then the opportunity system 104 can be configured to notify the user of the contact opportunity even if the user has requested contact opportunities that are located within 5 miles of the user's geographic location.

In some alternative implementations, the user can specify respective numeric weights that are assigned one or more presentation criteria. The system can determine contact opportunities by determining whether an aggregate of the weighted presentation criteria satisfies a threshold value.

The opportunity system 104 is configured to provide data describing the determined contact opportunities to the user device for presentation. The data can be provided to the user device over the network 101. The data can be presented on an interface 110 of the user device, as will be described in detail below in reference to FIGS. 3-9.

In some implementations, the opportunity system 104 is configured to provide the user device with updated contact opportunities for the user based on a change in the geographic location of the user device. For example, the user device can detect a change in its geographic location and, in response to detecting the change, the user device can communicate an update request to the opportunity system 104. Upon receiving the request, the opportunity system 104 can determine updated contact opportunities based on the user device's new geographic location. In some implementations, the opportunity system 104 polls the user device at specified time intervals, e.g., every 20 minutes, to determine whether the user device's geographic location has changed, and, in response to determining a change in the user device's geographic location, the opportunity system 104 can determine updated contact opportunities based on the user device's new geographic location. The specified time intervals can be a default time interval or can be user specified. In some implementations, a geographic location change is triggered when the user device's new geographic location meets or exceeds a threshold distance from the user device's last known geographic location.

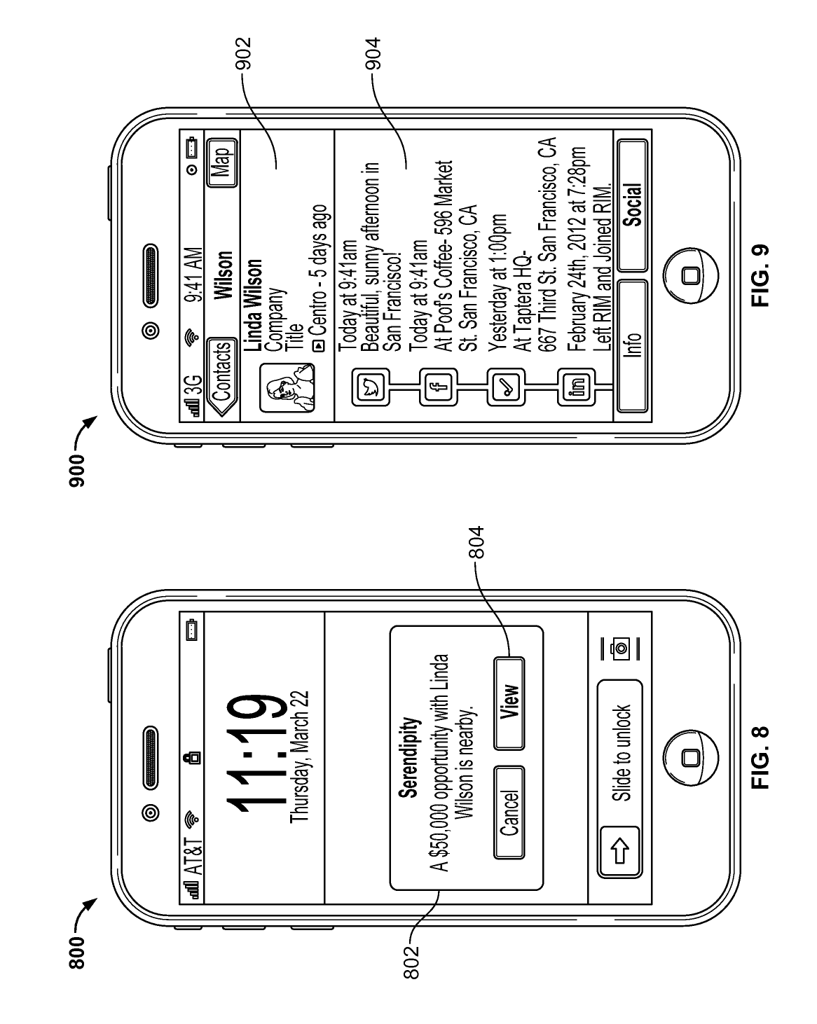

In some implementations, the opportunity system 104 is configured to obtain updated third-party content associated with the user's contacts. For example, the opportunity system 104 can poll and/or monitor third-party content providers 108 for updated third-party content associated with the user's contacts at specified time intervals, e.g., every 10 minutes. The opportunity system 104 can determine updated contact opportunities based in part on the updated third-party content, and can provide data describing the updated contact opportunities for presentation on the user device. For example, updated geographic locations of contact opportunities can be provided for presentation on a map interface of the user device. In some implementations, one or more of the updated contact opportunities are presented on the user device as push notifications, as described in reference to FIG. 8.

FIG. 2 is a flow diagram of an example process 200 for obtaining contact opportunities. For convenience, the process 200 will be described as performed by a system including one or more computing devices. For example, an opportunity system 104, as described in reference to FIG. 1, can be used to perform the process 200.

The system obtains data describing one or more contacts, e.g., customer contacts, of a user from a third-party content provider (202). The system can obtain data describing the customer contacts from a third-party content provider over a network, for example, as described in reference to FIG. 1.

The system matches the contacts to respective additional third-party content associated with the one or more customer contacts (204). An example of matching contacts to third-party content is described above in reference to FIG. 1.

The system derives geographic location information for one or more of the contacts based on the additional third-party content (206). In some implementations, the system derives geographic location information for the contacts using third party social information indicating contemporaneous social locations. The social locations represent geographic locations of contacts, as determined based on respective postings of third-party content. For example, the system can derive social geographic location information from social check-ins that identify a geographic location or point of interest. The system can also derive geographic location information from geotagging data, e.g., metadata identifying a geographic location of a contact at the time the content item was provided to the third-party content provider 106, that is included in third-party content items. Further, the system can derive geographic location information by geolocating a network address of a user device that was used to provide a content item to a third-party content provider.

In some cases, third-party content items may also include text that indicates a geographic location of a contact, e.g., “Spending the day at the de Young Museum.” In such cases, the system can derive geographic location information by parsing third-party content items to identify geographic location names that are referenced in the text and identifying text indicating a contact's presence at the geographic location.

In situations where there are several third-party content items that are associated with a contact, the system can derive geographic location information from the content items based on respective elapsed times since the content items were posted. For example, in a situation where a contact has posted multiple content item tags in a social networking content feed, the system can use the most recently posted content item tag to derive the most recent geographic location of the contact.

In some implementations, the system derives geographic location information for the contacts' office locations using respective business addresses, e.g., office locations, that were obtained for the contacts.

The system receives a geographic location of the user (208). The geographic location of the user can be derived based on a geographic location of the user device, as described above.

The system determines one or more contact opportunities (210). As described in reference to FIG. 1, the system can determine contact opportunities based on the geographic location of the user, the geographic location information for the contacts, one or more presentation criteria, or a combination thereof. For example, assuming a threshold distance of 5 miles, the system can determine that the user is located in San Francisco, Calif., and that 15 of the user's contacts are located within 5 miles of the user's location. These 15 contacts can be provided to the user as contact opportunities. Further, the system can filter these contacts based on additional presentation criteria specified by the user. For example, if the user has specified $50,000 as a threshold potential monetary value of a sales opportunity with a contact, then the system can filter the 15 contacts to identify contacts that satisfy the threshold potential monetary value, and can provide the identified contacts as contact opportunities.

The system provides data describing the contact opportunities to a user device for presentation (212). The data describing the contact opportunities can be presented on a user interface of the user device, as described in reference to FIGS. 3-9. In some implementations, the data describing the contact opportunities include one or more of a respective contact name, title, contact information, potential monetary value of sales opportunity, contact interest level, lead status, a likelihood of success, or a relevance to the user. Depending on the implementation, presentation criteria used to identify contact opportunities can include a measure of relevance of the contact opportunity to the user. For example, relevance of a contact opportunity to a user can be determined based on one or more of a geographic frequency, e.g., how often the contact is geographically located within a threshold distance from the user. Contact opportunity relevance can also be determined based on a freshness of the contact opportunity's location, e.g., the time of the contact's last known location. Further, contact opportunity relevance can also be determined based on the contact opportunity's location relative to the user's location, identification by the user of relevant contacts, and/or designations of contact opportunities as associated with the user. In some implementations, contacts with which a user is qualified to interact with, e.g., based on expertise or relationship, are categorized as being relevant to the user. In some implementations, the data describing the contact opportunities include geographic locations of the one or more contact opportunities. The geographic locations can be presented on a map interface of the user device. In some implementations, the contact opportunities include a respective contact name and a potential value of sales opportunity, the respective contact name and potential value of sales opportunity being presented in a push notification to the user device.

FIG. 3 illustrates an example interface 300 for presenting information describing contacts and contact opportunities that were identified for a user. The information can be presented to a user on a user device, as described in reference to FIG. 1. The interface 300 can be presented to a user, e.g., in response to a user login to the opportunity system, as described in reference to FIG. 1.

The interface 300 includes a contacts region 302 for displaying information about the user's contacts and a contact opportunities region 306 for displaying information about contact opportunities that were identified for the user. For example, the contacts region 302 can indicate a number of contacts 304 that were identified for the user based on, e.g., data obtained from a third-party sales content provider, as described in reference to FIG. 1.

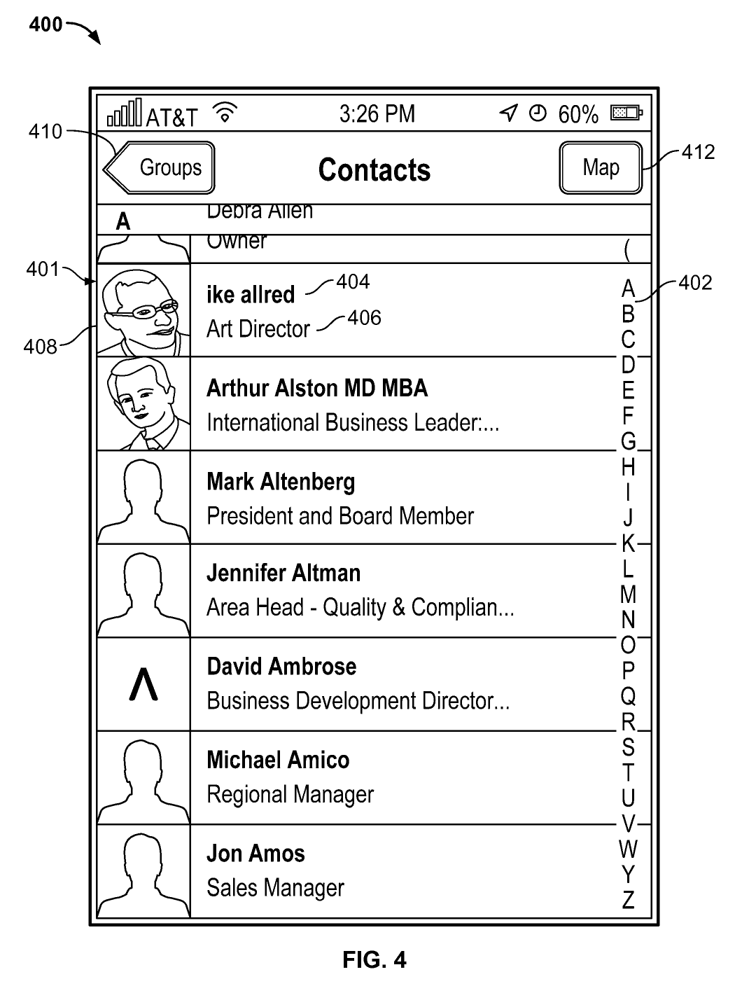

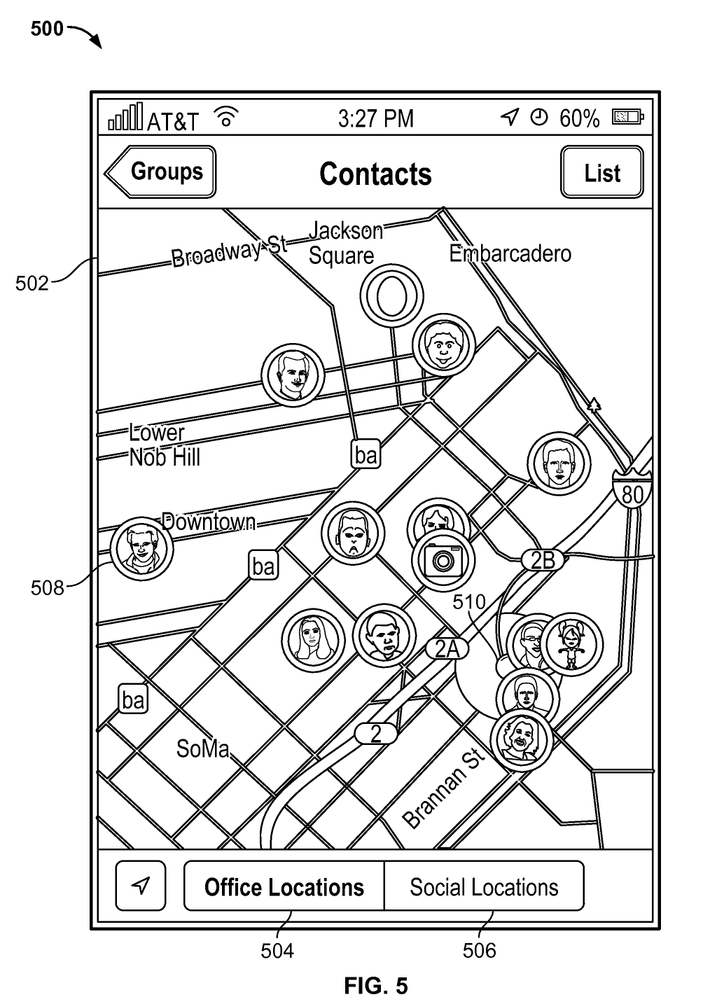

Similarly, the contact opportunities region 306 can indicate a number of contact opportunities 308 that were identified for the user. The contacts region 302 can be selected to view a listing of contacts that were identified for the user, as described below in reference to FIG. 4. Further, the contact opportunity region 306 can be selected to view contact opportunities that were identified for the user, as described below in reference to FIGS. 5-7.

FIG. 4 illustrates an example interface 400 for presenting a listing 401 of contacts that were identified for a user. The listing 401 can be presented to a user on a user device, as described in reference to FIG. 1.

The interface 400 presents a listing 401 of the user's contacts were identified for the user based on, e.g., data obtained from a third-party sales content provider, as described in reference to FIG. 1. The listing 401 includes entries, e.g., entry 402, for each of the user's contacts. Each entry includes information describing a respective contact. For example, the entry 402 includes a contact name 404, title 406, and an image 408 associated with the contact.

The interface 400 includes a button 410 for returning to an interface, e.g., interface 300, that provides information about contacts and contact opportunities that were identified for the user, as described in reference to FIG. 3. The interface 400 also includes a button 412 for viewing a map interface that indicates locations of one or more of the user's contacts, as described below in reference to FIGS. 5-7.

FIG. 5 illustrates an example map interface 500 indicating office locations of contacts that were identified for a user. The map interface 500 can be presented to a user on a user device, as described in reference to FIG. 1.

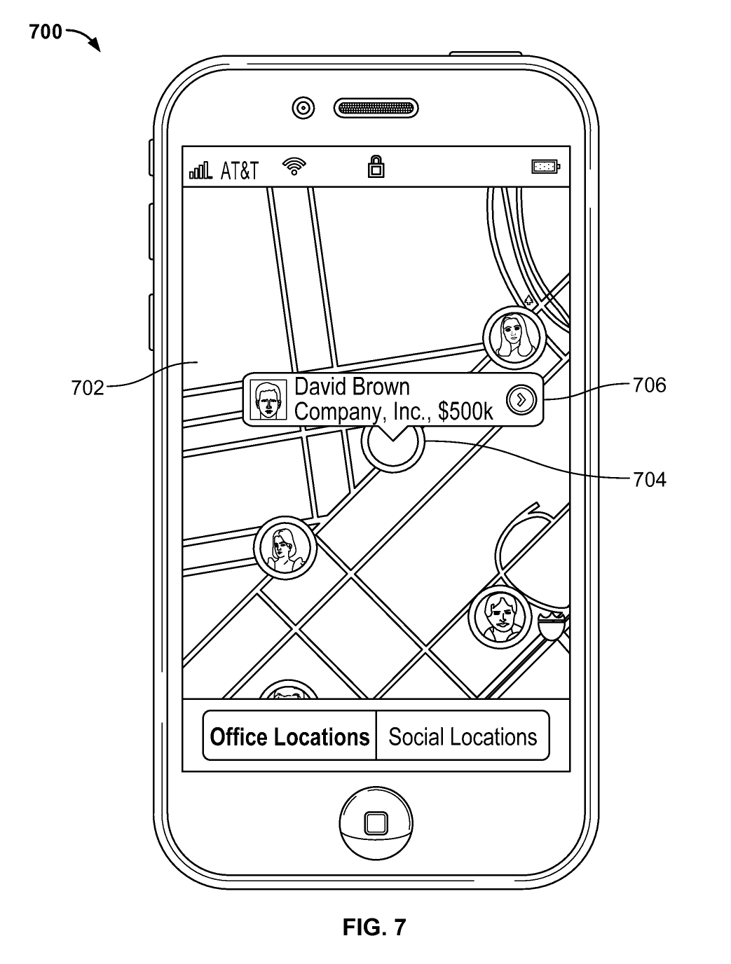

The map interface 500 includes a map region 502 displaying a geographic map of a region in which the user is located. A user location indicator 510 indicates the user's geographic location. The map region 502 displays contact office locations, e.g., location 508, that identify respective geographic locations of offices, e.g., business addresses, associated with the user's contacts. Each contact office location, e.g., location 508, can be presented along with information about the contact including, for example, images associated with the contacts. Further, each contact office location can be selected to display additional information describing the respective contact, as described in reference to FIGS. 7 and 9.

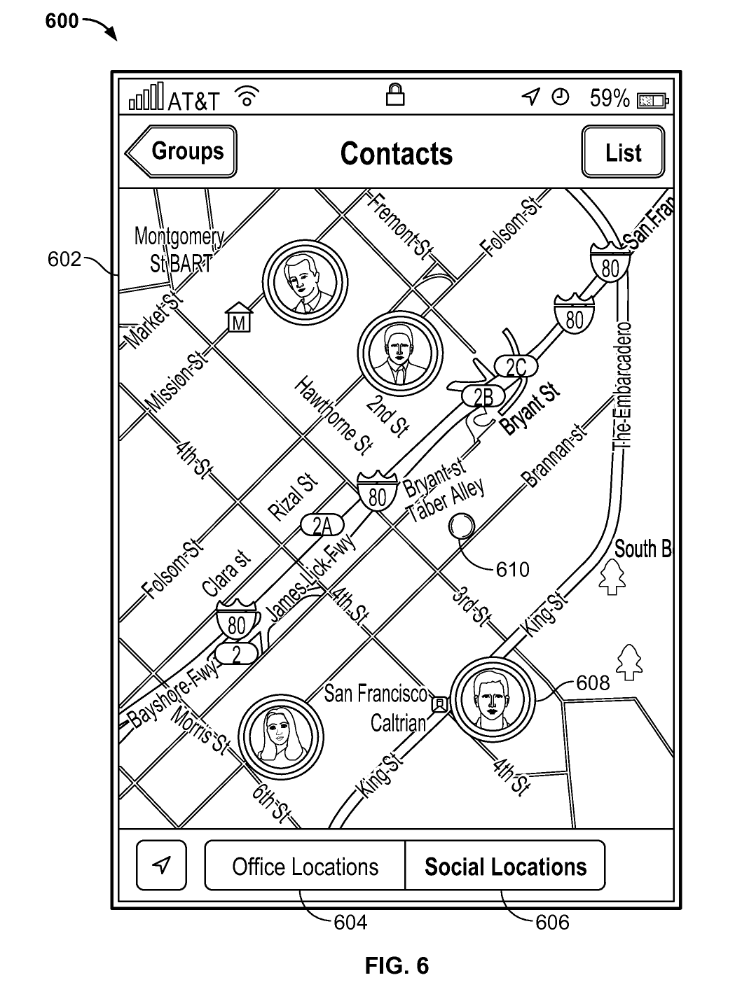

The map interface 500 also includes an option 506 for viewing social locations of the user's contacts that were derived based on third-party content, as described in reference to FIG. 6. The option 504 or 506 can be selected to alternate between views of office locations and social locations, respectively.

FIG. 6 illustrates an example map interface 600 indicating social locations of contacts that were identified for a user. The map interface 600 can be presented to a user on a user device, as described in reference to FIG. 1.

The map interface 600 includes a map region 602 displaying a geographic map of a region in which the user is located. A user location indicator 610 indicates the user's geographic location. The map region 602 displays social locations, e.g., location 608, that identify geographic locations of contacts that were derived based on respective third-party content associated with the user's contacts. Based on data associated with the third-party content, a contact's social location can be a current, e.g., contemporaneous, location or a last known location. In some implementations, the last known location, as determined based on third-party content, is displayed if an elapsed time of the third-party content is within a threshold time period, e.g., last known within a specified number of minutes, hours, or days.

Each social location, e.g., location 608, can be presented along with information about the contact including, for example, images associated with the contacts. Further, each social location can be selected to display additional information describing the respective contact, as described in reference to FIGS. 7 and 9. The map interface 600 also includes an option 604 for viewing office locations of the user's contacts that were derived based on third-party content, as described in reference to FIG. 5. The option 604 or 606 can be selected to alternate between views of office locations and social locations, respectively.

FIG. 7 illustrates an example map interface 700 indicating locations of contacts that were identified for a user. The locations can be office or social locations of the contacts. The map interface 700 can be presented to a user on a user device, as described in reference to FIG. 1.

The map interface 700 includes a map region 702 displaying a geographic map of a region in which the user is located. Each contact location, e.g., location 704, can be presented along with information about the contact including, for example, images associated with the contacts. Further, each social location can be selected to display additional information, e.g., the information box 706, describing the respective contact. The additional information can include, for example, a contact name, company title, and a potential monetary value of the contact opportunity, for example, with respect to sales or a business negotiation. The user can select the information box 706 to view additional information about the contact including, e.g., the contact's title, contact information, e.g., location address, e-mail address, and phone numbers, contact interest level, lead status, and/or a likelihood of success.

FIG. 8 illustrates an example push notification 802 displayed on an interface 800 of a user device. The interface 800 can be presented to a user on a user device, as described in reference to FIG. 1. In some implementations, a push notification is presented on the interface of a user device in response to identification of a contact opportunity for the user. For example, the push notification can be presented when the user is within a threshold geographic distance from the contact. In addition, or in the alternative, the push notification can be presented when one or more presentation criteria are satisfied. The user can select an option 804 to view additional details about the contact opportunity including, e.g., the contact's title, contact information, e.g., location address, e-mail addresses, and phone numbers, contact interest level, lead status, and/or a likelihood of success. In some implementations, the user can select an option, e.g., option 804, to view the contact's location history, as described in reference to FIG. 9.

FIG. 9 illustrates an example interface 900 displaying a contact's location history 902 displayed on an interface 900 of a user device. The interface 900 can be presented to a user on a user device, as described in reference to FIG. 1. The contact's location history 902 provides a history of the contact's locations that were determined based on third-party content associated with the contact, as described in reference to FIG. 1. Each location entry, e.g., entry 904, can indicate the contact's location, third-party content from which the location was derived, a timestamp of the third-party content, and information, e.g., a name and/or image, indicating a social network from which the third-party content was obtained.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
obtaining data describing one or more customer contacts of a user from a third-party content provider;
matching the one or more customer contacts to respective additional third-party content associated with the one or more customer contacts;
deriving geographic location information for one or more of the customer contacts based on the additional third-party content;
receiving a geographic location of the user;
determining one or more contact opportunities based on the geographic location of the user, the geographic location information for the one or more customer contacts, and one or more presentation criteria; and
providing data describing the one or more contact opportunities to a user device for presentation, wherein the data is presented on a user interface of the user device.

2. The method of claim 1, wherein the geographic location information for one or more of the customer contacts is derived based on a respective content item tag and an elapsed time of the respective content item tag.

3. The method of claim 1, wherein the additional third-party content comprises content feeds from one or more social networks.

4. The method of claim 1, wherein the data describing the one or more contact opportunities includes a respective contact name, title, contact information, potential monetary value of sales opportunity, contact interest level, lead status, an estimated likelihood of success, or a relevance to the user.

5. The method of claim 1, wherein the data describing the one or more contact opportunities includes geographic locations of the one or more contact opportunities, the geographic locations being presented on a map interface of the user device.

6. The method of claim 1, wherein data describing the one or more contact opportunities includes a respective contact name and a potential value of sales opportunity, the respective contact name and potential value of sales opportunity being presented in a push notification to the user device.

7. The method of claim 1, wherein determining one or more contact opportunities based on the geographic location of the user, the geographic location information for one or more of the customer contacts, and one or more presentation criteria comprises:
determining, based on the geographic location information for the customer contacts, that a customer contact is located within a threshold distance to the geographic location of the user; and
determining that the customer contact satisfies one or more presentation criteria, the presentation criteria comprising a respective potential monetary value of a sales opportunity, customer interest level, lead status, a likelihood of success, or a relevance to the user.

8. The method of claim 1, wherein matching the one or more customer contacts to additional third-party content associated with one or more of the customer contacts comprises:
identifying respective e-mail addresses associated with the one or more customer contacts;
identifying additional third-party content that is associated with the respective e-mail addresses, wherein the additional third-party content includes geographic location data; and
determining, using the identified additional third-party content, respective geographic locations for the one or more customer contacts.

9. The method of claim 8, wherein the geographic location is determined based on a geographic location name referenced in the additional third-party content.

10. The method of claim 8, wherein the geographic location is determined based on a network address of a user device that was used to provide the additional third-party content to a content provider.

11. The method of claim 8, wherein the geographic location is determined based on a check-in location referenced in the additional third-party content.

12. A system comprising:
one or more computers and one or more storage devices storing instructions that are operable, when executed by the one or more computers, to cause the one or more computers to perform operations comprising:
obtaining data describing one or more customer contacts of a user from a third-party content provider;
matching the one or more customer contacts to respective additional third-party content associated with the one or more customer contacts;
deriving geographic location information for one or more of the customer contacts based on the additional third-party content;
receiving a geographic location of the user;
determining one or more contact opportunities based on the geographic location of the user, the geographic location information for the one or more customer contacts, and one or more presentation criteria; and
providing data describing the one or more contact opportunities to a user device for presentation, wherein the data is presented on a user interface of the user device.

13. The system of claim 12, wherein the geographic location information for one or more of the customer contacts is derived based on a respective content item tag and an elapsed time of the respective content item tag.

14. The system of claim 12, wherein the additional third-party content comprises content feeds from one or more social networks.

15. The system of claim 12, wherein the data describing the one or more contact opportunities includes a respective contact name, title, contact information, potential monetary value of sales opportunity, contact interest level, lead status, an estimated likelihood of success, or a relevance to the user.

16. The system of claim 12, wherein the data describing the one or more contact opportunities includes geographic locations of the one or more contact opportunities, the geographic locations being presented on a map interface of the user device.

17. The system of claim 12, wherein data describing the one or more contact opportunities includes a respective contact name and a potential value of sales opportunity, the respective contact name and potential value of sales opportunity being presented in a push notification to the user device.

18. The system of claim 12, wherein determining one or more contact opportunities based on the geographic location of the user, the geographic location information for one or more of the customer contacts, and one or more presentation criteria comprises:
determining, based on the geographic location information for the customer contacts, that a customer contact is located within a threshold distance to the geographic location of the user; and
determining that the customer contact satisfies one or more presentation criteria, the presentation criteria comprising a respective potential monetary value of a sales opportunity, customer interest level, lead status, a likelihood of success, or a relevance to the user.

19. The system of claim 12, wherein matching the one or more customer contacts to additional third-party content associated with one or more of the customer contacts comprises:
identifying respective e-mail addresses associated with the one or more customer contacts;
identifying additional third-party content that is associated with the respective e-mail addresses, wherein the additional third-party content includes geographic location data; and
determining, using the identified additional third-party content, respective geographic locations for the one or more customer contacts.

20. A non-transitory computer storage medium encoded with instructions that, when executed by one or more computers, cause the one or more computers to perform operations comprising:
obtaining data describing one or more customer contacts of a user from a third-party content provider;
matching the one or more customer contacts to respective additional third-party content associated with the one or more customer contacts;
deriving geographic location information for one or more of the customer contacts based on the additional third-party content;
receiving a geographic location of the user;
determining one or more contact opportunities based on the geographic location of the user, the geographic location information for the one or more customer contacts, and one or more presentation criteria; and
providing data describing the one or more contact opportunities to a user device for presentation, wherein the data is presented on a user interface of the user device.
